(19) United States
(12) Patent Application Publication
(10) Pub. No.: US 2012/0123051 A1
(43) Pub. Date: May 17, 2012

(54) ADHESIVE SILICONE RUBBER COMPOSITION

(75) Inventor: Kotaro Kuwata, Kanagawa-pref. (JP)

(73) Assignee: WACKER CHEMIE AG, Munich (DE)

(21) Appl. No.: 13/387,395

(22) PCT Filed: Jul. 23, 2010
(86) PCT No.: PCT/EP10/60732

§ 371 Date: Jan. 27, 2012

(30) Foreign Application Priority Data
Jul. 29, 2009 (JP) 2009-176211

(51) Int. Cl. C09J 183/07

(52) U.S. Cl. 524/588

(57) ABSTRACT

An object of the invention is to provide an adhesive silicone rubber composition which has superior adhesion to various thermoset resins, especially to polyurethane. The composition comprises of (A) a polyorganosiloxane having at least two alkenyl groups, (B) a polyorganohydrogensiloxane which has at least two hydrogen atoms bonded to silicon atoms, (C) an organosilicon compound having aromatic hydrocarbon group and alkoxy group bonded to silicon atom, (D) an organometal compound which can be catalyst for condensation reaction of (C) component, (E) a polyorganosiloxane resin, and (F) catalytic amount of hydrosilylation reaction catalyst.

### CROSS-REFERENCE TO RELATED APPLICATIONS

This application claims priority to Japanese Patent Application No. JP 2009-176211 filed Jul. 29, 2009.

### BACKGROUND OF THE INVENTION

### Field of the Invention

The present invention relates to an addition curing type silicone composition, and more particularly to an addition curing composition that can be cured quickly by heating and can become cured materials which show excellent adhesion to thermoset resins, especially to polyurethane after curing, without loss of adhesive strength and change of hardness over time.

Addition type curing compositions, curable using platinum catalysts, and having as major components an alkenyl group-containing polyorganosiloxane and polyorganohydrogensiloxane, are used in various industrial areas. In recent years, there have been active developments in the area of high value applications such as automobile, electronics/electrics and medical, and especially in integrating silicone elastomers and organic resin into one-piece composite structures. Thermoplastic resins such as PBT, polycarbonate, polyamide and so on, have been usually used as organic resins for the integration. In the case of thermoset resins, such as polyurethane, epoxy, and phenolic novolac resins, adhesion to silicone was not necessarily easy. Especially when polyurethanes are used together with silicone to provide the abrasive properties and low permeability to water, oil and salt of polyurethanes, a complicated pretreatment of the silicone rubber base material, such as plasma treatment, application of primer or UV treatment, was required. In the past, there have been various proposals and actual applications for using so called self-adhesive silicone rubber compositions, which are addition curing silicone rubber compositions with adhesive properties, by applying them directly to the surface of base resins without applying treatment such as ozone or primer.

For self-adhesive silicone rubber compositions, there have been many proposals having the essential feature of formulating alkoxysilanes and condensation catalysts as adhesion promoters. For example, in Japanese laid open JP 60-101146 there is proposed formulating an adhesive polyorganosiloxane composition with an epoxy group-containing alkoxysilane as an adhesion promoter in the addition curing silicone rubber composition. However, by this method, there arise several problems of insufficient adhesion to thermoset resins, change of hardness over time by the effect of unreacted alkoxy groups of the adhesion promoter at the curing stage, and release from the mold.

There are also proposals of silicone compositions which do not require primer for adhesion to the thermoset resins. In Japanese laid open JP 10-330620, an addition curing silicone composition containing an alkenyl-containing organopolysiloxane whose main siloxane chain is branched by a silyl group bearing a phenolic group, anhydride group or carboxyl group bonded to silicon is disclosed. The composition showed adhesive strength after curing when it was used by pressing the composition to thermoset resin in a non-curing stage. However, it is not easy to prepare polyorganosiloxanes which have branched, functional silyl group due to requiring many reaction steps, and further improvement in adhesive strength to thermoset resin is required.

An addition curing type silicone composition, which contains an alkylene glycol ester of diacrylic acid or an alkylene glycol ester of dimethacrylic acid as an adhesion promoter for various substrates including thermoset resins, and a release agent to the mold, is proposed in Japanese laid open JP 2007-500266. However, further improvement of adhesive strength to thermoset resin is required although the composition can be used for various substrates including thermoset resins.

It is an object of the invention to provide an addition curing type composition that can be cured quickly by heating and can become a cured material which shows excellent adhesion to thermoset resins without loss of adhesive strength and change of hardness over time. It has now been surprisingly discovered that these and other objects are achieved by adding an organosilicon compound having an aromatic hydrocarbon group and an alkoxy group bonded to silicon, an organometal compound which is a condensation catalyst, and a polyorganosiloxane resin to the addition curing silicone compound.

### DETAILED DESCRIPTION OF THE PREFERRED EMBODIMENTS

Therefore the present invention is directed to

[1] A silicone rubber composition, which is adhesive to thermoset resins, comprising:

(A) 100 parts by weight of a polyorganosiloxane having at least two siloxane units represented by general formula (1) and a viscosity of 10 to 500,000 mPa·s at 25° C.,

R¹ₐR²_{b}SiO_{(4-a-b)/2} (1),

wherein

R¹ is alkenyl group,

R² is substituted or unsubstituted monovalent hydrocarbon group free from aliphatic unsaturated bonds,

a is 1 or 2,

b is 0, 1 or 2,

and the sum of a and b is 1, 2 or 3,

(B) a polyorganohydrogensiloxane comprising siloxane units represented by general formula (2) and which has at least two hydrogen atoms bonded to silicon atoms, in an amount such that the ratio of hydrogen atoms bonded to silicon atoms in component (B) to alkenyl group in component (A) is 0.5 to 7.0,

R²_{c}H_{d}SiO_{(4-c-d)/2} (2),

wherein

R² is substituted or unsubstituted monovalent hydrocarbon group free from aliphatic unsaturated bonds,

c is 0, 1, 2 or 3,

d is 0, 1 or 2,

and the sum of c and d is 1, 2 or 3,

(C) 0.01 to 10 parts by weight of an organosilicon compound having an aromatic hydrocarbon group and an alkoxy group bonded to silicon,

(D) 0.01 to 5 parts by weight of an organometal compound which is a catalyst for a condensation reaction of component (C),

(E) 10 to 200 parts by weight of a polyorganosiloxane resin, represented by general formula (3) for average siloxane unit, which comprises of 0 to 80 mol % of triorganosiloxane units, 0 to 60 mol % of diorganosiloxane units, 0 to 80 mol % of monoorganosiloxane units and 0 to 60 mol % of SiO_{4/2} units which do not have an organic group,

R³ₑSiO_{(4-e)/2} (3),

wherein

R³ are identical or different alkyl or alkenyl groups of 1 to 12 carbon atoms,

e is 0.5 to 2.0, and

(F) a catalytic amount of a hydrosilylation reaction catalyst.

[2] A silicone rubber composition as in the above [1], wherein the (E) component is a polyorganosiloxane resin containing at least one alkenyl group.

[3] A silicone rubber composition as in the above [1] or [2], wherein the (E) polyorganosiloxane resin contains triorganosiloxane units of 10 to 80 mol. % and SiO_{4/2} units having no organic groups, of 20 to 90 mol. %, among all siloxane units.

[4] A silicone rubber composition as in one of the above [1] to [3], further containing (G), an organoalkoxysilane in an amount of 0.01 to 20 parts by weight.

The addition curing silicone composition of the present invention is notable for its quick curing speed, excellent adhesion to various thermoset resins and sustaining adhesive strength and hardness for an extended period of time. The composition of the present invention can be used widely as a self-adhesive silicone rubber, especially by its excellent adhesion to polyurethane or epoxy resin which is thought to be difficult to adhere.

Hereinafter, the present invention will be described in greater detail.

The (A) component of the polyorganosiloxane used in the present invention has at least two alkenyl groups bonded to silicon atoms in one molecule. This polyorganosiloxane comprises of at least two siloxane units represented in aforementioned formula (1) and further polysiloxane units represented by general formula (4).

R²_{f}SiO_{(4-f)/2} (4)

In general formula (4),

R² is same with those in general formula (1),

and f is integer number of 1 to 3.

The polyorganosiloxane may be linear or branched, or mixture of these. This polyorganosiloxane may be produced by methods known in the state of the art. The polyorganosiloxane is preferably linear because the preparation of such polyorganosiloxanes is easy, they have high fluidity and elastic silicone rubber is obtained.

Alkenyl group R¹ in the above general formula (1) preferably contains 2-6 carbon atoms, and examples include vinyl, allyl, 1-butenyl and 1-hexenyl. The vinyl group is preferable for economical reasons and ease of production.

R² in the general formulae (1) and (4) is a substituted or unsubstituted monovalent hydrocarbon having from 1-12 carbon atoms. Examples include alkyl groups such as methyl, ethyl, propyl, butyl, hexyl and dodecyl; aryl groups such as phenyl; and substituted hydrocarbon groups such as chloromethyl and 3,3,3-trifluoropropyl. The methyl group is the most preferable among the above examples as it is economical and easy to produce, and the viscosity of the polyorganosiloxane is low while it has enough polymerisation number to maintain good physical properties after curing. Optionally other hydrocarbon can be selected, such as phenyl groups in case the cured materials require resistance to cold or specific optical properties, and the 3,3,3-trifuluorpropyl group in case the cured materials require oil resistance.

Further, the alkenyl-containing units represented by the above general formula for the (A) component, which is a base polymer for the addition curing polyorganosiloxane, may be at the terminus or in the middle of the polymer chain. It is preferable that at least one terminal alkenyl group exists to achieve good mechanical properties after curing.

No limitation is imposed on the viscosity of the (A) component, however, it is preferable that the viscosity of the (A) component is in the range of 10 to 500,000 mPa·s at 25° C. A viscosity of 100 to 250,000 mPa·s is further preferable, especially for usage which requires higher fluidity of the composition before curing and excellent mechanical properties after curing.

The (B) component of polyorganohydrogensiloxane in the present invention is a necessary component to cure the composition to elastomer or gel-like materials by the addition reaction with the alkenyl group in (A) component. There is no limitation on the molecular structure of (B) component, such as linear, cyclic or branched, as long as it contains more than two of Si—H bonds in one molecule. From ease of production, a preferable structure is a linear polyorganohydrogensiloxane or branched polyorganohydrogensiloxane comprising of R²₂HSiO_{1/2} units and SiO₂ units.

Examples of R² in the aforementioned general formula (2) are the same as those exemplified for the formula (1). The R² of the formula (2) may be identical or different in the component (B) and may be same or different from those of the formula (1). R² of the formula (2) is preferably methyl and/or phenyl for heat resistance and adhesion to base materials. The most preferable (B) component is a polymethylhydrogensiloxane having (CH₃)HSiO_{2/2} units and (CH₃)₂SiO_{2/2} units, and a polymethylphenylhydrogensiloxane having (CH₃)HSiO_{2/2} units, and (CH₃)₂SiO_{2/2} and (CH₃) (C₆H₅) SiO_{2/2} units. These polyorganohydrogensiloxanes may be produced by known methods in the state of the art.

The (B) component in the composition is used in an amount of (B) to make the ratio of silicon-bonded hydrogen atoms to alkenyl groups of R¹ in the component (A) 0.5 to 7.0, preferably 0.7 to 5.0, more preferably 0.8 to 3.0. At less than 0.5, curing of the composition is not enough, and at more than 7.0, it tends to foam at curing, and produce lower adhesion and changes in mechanical properties, especially heat resistance.

The organosilicon compound of the (C) component in the present invention is used for promoting excellent self-adhesion to the composition together with the organometal compound (D) component. The organosilicon compound has at least one aromatic hydrocarbon group in the molecule and at least one alkoxy group bonded to silicon. Optionally, within the spirit and the concept of the present invention, the silicon compound of the (C) component may have halogen groups such as chlorine or bromine, and functional groups such as amino, amide, mercapto, sulfide, cyano, carbonyl, carboxyl, hydroxyl, epoxy, hydrogen bonded to silicon, methacryl, acryl, and ether bonded oxygen.

The (C) component of the present invention preferably contains at least one aromatic group represented in general formulae (5) to (8);

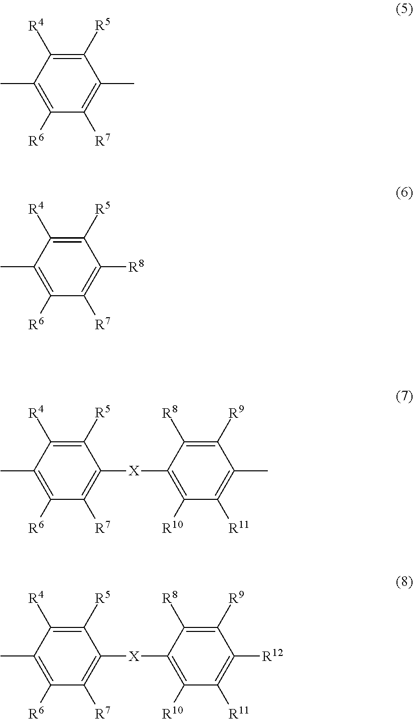

In the formula (5) to (8), R⁴ to R¹² are identical or different monovalent groups selected from hydrogen, halogen, hydroxyl, alkoxy or hydrocarbons having 1 to 8 carbon atoms which are unsubstituted or substituted by halogen or cyano groups. X may be a covalent bond or may be a divalent group, including those below as illustrative examples;

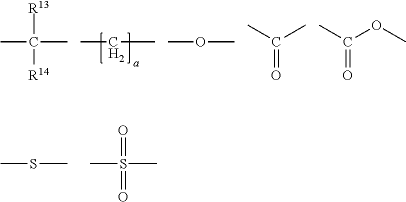

R¹³ and ^{R}¹⁴ are identical or different groups selected from hydrogen, halogen, hydroxyl, monovalent hydrocarbon groups having 1 to 8 carbon atoms which are unsubstituted or substituted by halogen or cyano, or are a carbocyclic or heterocyclic cyclic group resulting from bonding R¹³ and R¹⁴, and a is integer number of 2 to 8.)

Examples of such organosilicon compounds are illustrated below. In the illustrative examples, compounds which do not contain alkenyl groups are preferable to achieve the object of the present invention, although the compounds which contain alkenyl group are within this invention. In the illustrative examples, Me is methyl, Et is ethyl, Pr is propyl and n is integer number of 1 to 20.

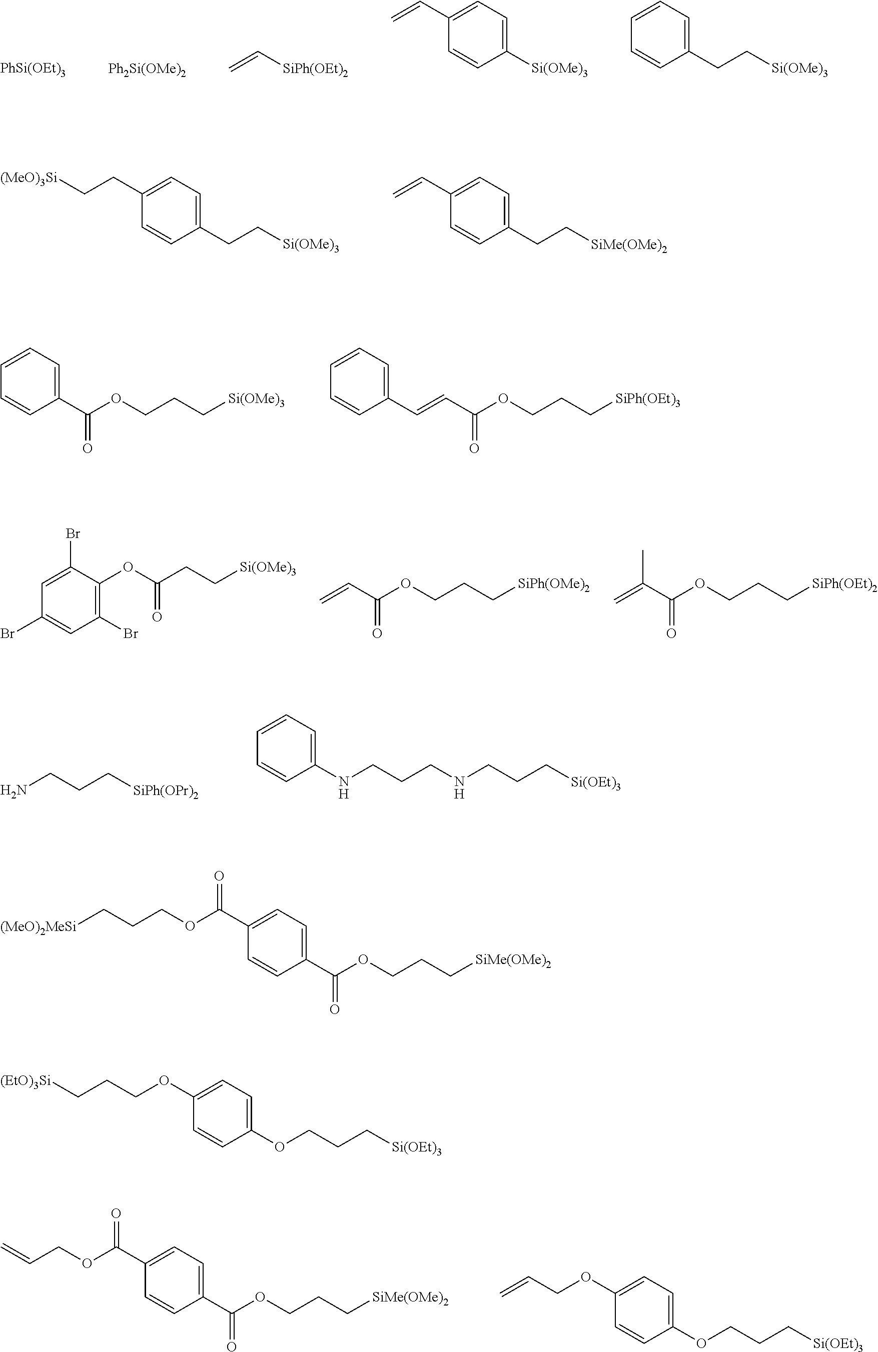

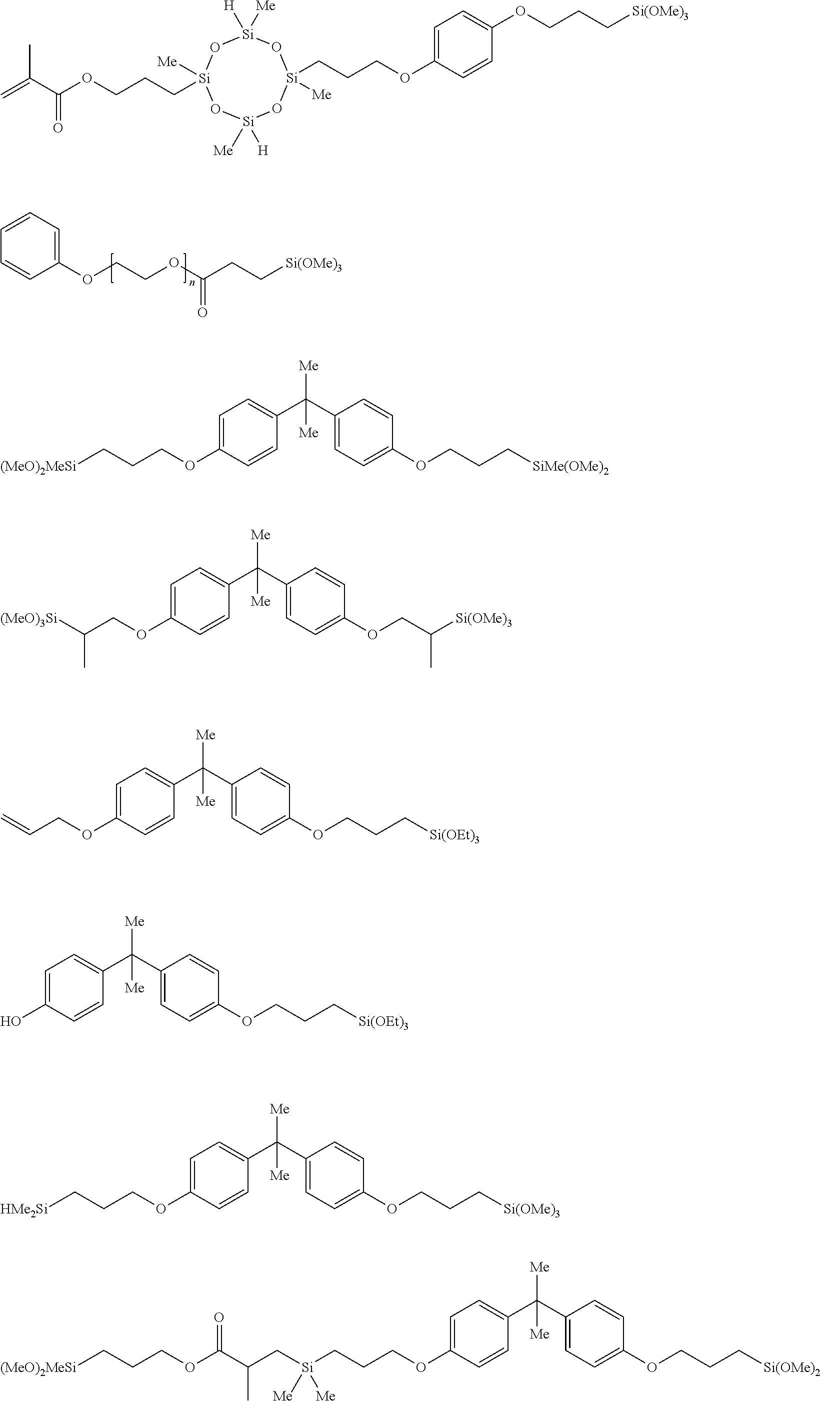

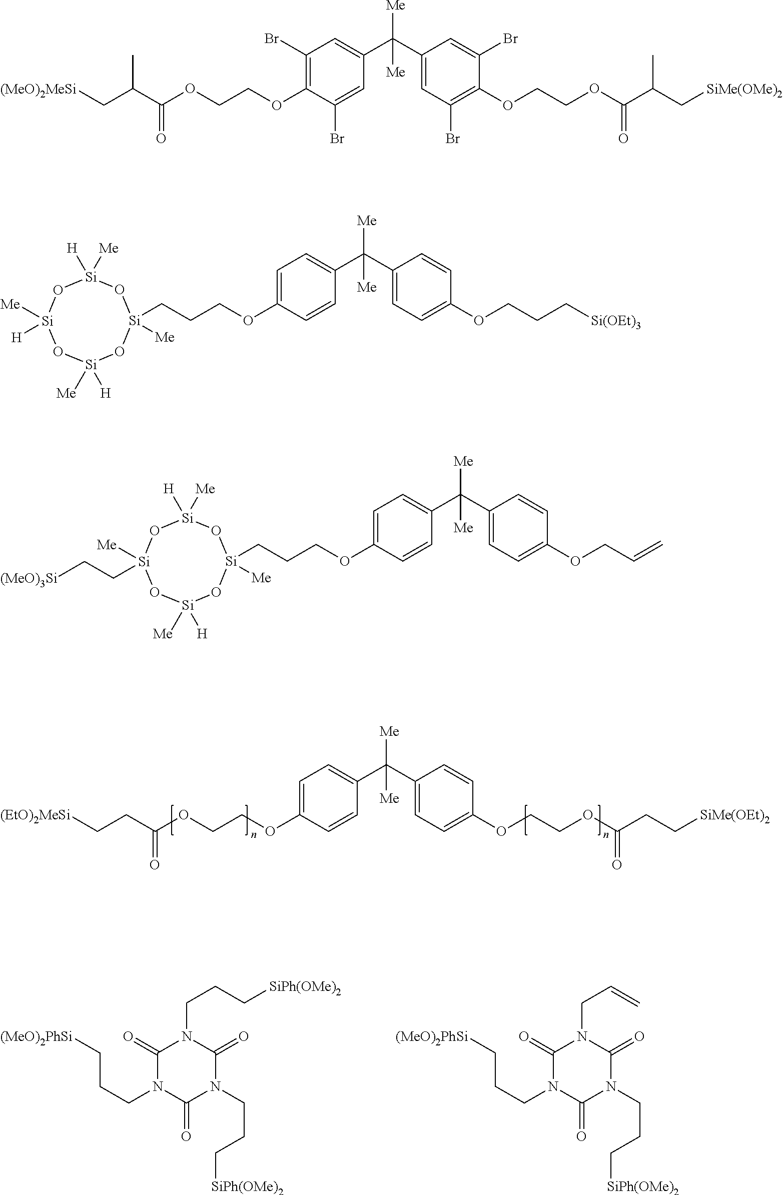

For the (C) component of the present invention, the most preferable example is shown below in general formula (9). In formula (9), R¹⁵ to R¹⁸ are identical or different, substituted or unsubstituted saturated monovalent aliphatic hydrocarbon groups having 1-8 carbon atoms, or substituted or unsubstituted monovalent aromatic hydrocarbon groups having 6-18 carbon atoms, p is 1, 2 or 3, q is 0, 1 or 2 and p+q is 3.

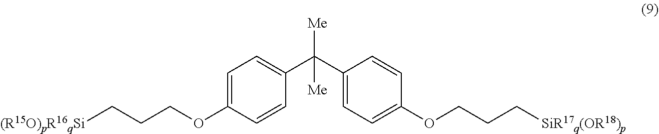

The organosilicon compounds of the (C) component which are useful to promote adhesive properties of the silicone composition in the present invention may be used independently, or more than two of those may be used to achieve better adhesion to the substrates. The quantity of the organosilicon compounds is 0.1 to 10 parts by weight, preferably 0.2 to 2 parts by weight to 100 parts by weight, relative to (A) component. Adhesive strength is not enough at less than 0.1 parts by weight, and at more than 10 parts by weight the physical properties of elastomer after curing of the compound is deteriorated.

The organosilicon compounds may be prepared by using methods of synthesis, procedures of synthesis, properties and methods of handling described in JIKKEN KAGAKU KOUZA (Experimental Chemistry Course) Version 4, Volume 24 “Organic synthesis VI, typical metal compounds”, published by Maruzen Co. (1992), edited by Japan Chemical Society; and JIKKEN KAGAKU KOUZA (Experimental Chemistry Course) Version 4, Volume 25 “Organic synthesis VII, Synthesis by organometal reagent”, published by Maruzen Co. (1992), edited by Japan Chemical Society.

Typical examples of the synthesis are, for example; (1) alkoxy reaction between alcohol and silane which is alkylated by Grignard agent after hydrosilylation of a commercial alkenyl compound by chlorosilane having Si—H, (2) alkoxy reaction by alcohol to silane which is a hydrosilylation reaction product of commercial alkenyl compound by chlorosilane having Si—H, (3) hydrosilylation of a commercial alkenyl compound by alkoxysilane having Si—H.

The organometal compound of (D) component in the present invention is used to promote adhesion of the composition together with the organosilicon compound of (C) component and to minimize the change of hardness after curing over time. Examples of the preferred organometal compounds include metal alkoxides such as methoxides, ethoxides or propoxides of metals such as B, Al, Ti, V, Cr, Mn, Fe, Co, Ni, Cu, Zn, Zr, Mo, Ru, Rh, Pd, Ag, Cd, Sn, Os, Ir, Hg and rare-earth metals; metal salts of fatty acids such as metal stearate and metal octylate; metal chelates such as metal acetylacetonate; metal octyleneglycolates and metal ethylacetoacetate. From the availability of the compound and effect on reactivity and adhesion promotion, preferred examples include metal alkoxides, metal salts of fatty acids and metal chelates of B, Al, Ti or Zr. Particularly preferred examples are tetra(n-butoxy)zirconium, tetrapropoxyzirconium, zirconiumtetraacetylacetonate, tetra(n-butoxy)titanate, diisopropoxytitaniumbis(acetylacetonate), aluminum tris(ethylacetoacetate), aluminum tris(acetylacetonate) and boron isopropoxide. The alcohol component for the alkoxides may be a commodity type alcohol such as isopropanol or butanol from availability, or a high molecular weight alcohol derived from natural product or synthesis may be used from the consideration on the storage stability of the addition curing type silicone.

The (D) component compounds may be used singly, or more than two of those may be used to achieve better adhesion to the thermoset resin. The quantity of the organometal compounds is 0.01 to 5 parts by weight, preferably 0.02 to 2 parts by weight. At less than 0.01 parts by weight, enough adhesive strength is not obtained as the effect of the compound as a condensation catalyst is not enough, and at more than 5 parts by weight, the physical properties or heat resistance of elastomer after curing of the compound is deteriorated.

The polyorganosiloxane resin of the (E) component in the present invention is an indispensable component, the purpose of which is not limited to promoting adhesion to various thermoset resins for the addition curing silicone composition, but also to improve mechanical strength of base polymer. The polyorganosiloxane resin of (E) component comprises of triorganosiloxane units (M units) of 0 to 80 mol %, diorganosiloxane units (D units) of 0 to 60 mol %, monoorganosiloxane units (T units) of 0 to 80 mol % and SiO_{4/2} units (Q units) of 0 to 60 mol %. Average unit composition of those units is represented by the general formula (3) R³ₑSiO_{(4-e)/2}, wherein e, which indicates the average of the composition in the general formula (3), is 0.5 to 2.0. Preferably, the polyorganosiloxane resin is a resin consisting of M and Q units with triorganosiloxane units of 10 to 80 mol % and SiO_{4/2} units (Q units) of 20 to 90 mol % in the total of siloxane units. The polyorganosiloxane can be produced by the known method of hydrolysis and condensation reaction of relevant chlorosilanes or alkoxysilanes, which is known in the state of the art.

R³ in the general formula (3) for the (E) component in the present invention are identical of different alkyl groups or alkenyl groups having 1 to 12 carbon atoms, the alkyl groups are the same as with the aforementioned R², and the alkenyl groups are the same as with the aforementioned R¹. The (E) component of the present invention preferably contains at least one alkenyl group in the molecule, because improvement of adhesive properties is achieved together with the mechanical strength of base polymer by incorporating the alkenyl group to the matrix of the base polymer through the addition reaction.

The quantity of the polyorganosiloxane resin is 10 to 200 parts by weight to 100 parts by weight of (A) component, preferably 20 to 100 parts by weight. At less than 10 parts by weight enough adhesive strength and mechanical properties are not obtained, and at more than 200 parts by weight the physical properties or elastomer after curing of the compound is deteriorated.

The hydrosilylation catalyst of component (F) in the present invention is used as a catalyst for the addition reaction, generally termed a hydrosilylation reaction, between the alkenyl group R¹ of the (A) polyorganosiloxane and the hydrogen atom bonded to silicon atom of the (B) polyorganohydrogensiloxane. The hydrosilylation reaction catalyst is a metal such as platinum, rhodium, palladium, ruthenium, and iridium, and compounds thereof. Among these hydrosilylation catalysts, the most preferred are platinum or platinum compounds.

Examples of suitable platinum compounds include platinum black, platinum halides (such as PtCl₄, H₂PtCl₄.6H₂O, Na₂PtCl₄.4H₂O, and reaction products of H₂PtCl₄.6H₂O and cyclohexane), platinum-olefin complexes, platinum-alcohol complexes, platinum-alcoholate complexes, platinum-ether complexes, platinum-aldehyde complexes, platinum-ketone complexes, platinum-vinylsiloxane complexes (such as platinum-1,3-divinyl-1,1,3,3-tetramethyldisiloxane complex), bis-(γ-picoline)-platinumdichloride, trimethylenedipyridine-platinumdichloride, dicyclopentadiene-platinumdichloride, cyclooctadiene-platinumdichloride, cyclopentadiene-platinum dichloride, bis(alkynyl)bis(triphenylphosphine)-platinum complex, and bis(alkynyl)(cyclooctadiene)-platinum complex.

The hydrosilylation reaction catalyst may also be used in a microcapsulated form. Example of the microcapsules are ultra fine particles of a thermoplastic resin (such as a polyester resin or a silicone resin) which contains the catalyst and is insoluble in the organopolysiloxane. Furthermore, the hydrosilylation reaction catalyst may also be used in the form of a clathrate compound, for example, the catalyst enclosed within cyclodextrin. The hydrosilylation reaction catalyst is used in an effective quantity, or so-called catalytic quantity.

A typical quantity, expressed as a metal equivalent value, is within a range of 0.1 to 1000 ppm relative to the component (A), and quantities from 0.5 to 200 ppm are preferred.

The organoalkoxysilane (G) component in the present invention may be used to further improve adhesion to thermoset resins. Examples of the silane are vinyltrimethoxysilane, vinyltriethoxysilane, vinyltris(β-methoxyethoxy)silane, vinyldiethoxymethylsilane, allyltrimethoxysilane, acryloyloxymethyltrimethoxysilane, γ-methacryloyloxypropyltrimethoxysilane, γ-glycidyloxypropyltrimethoxysilane, γ-aminopropyltrimethoxysilane, γ-aminopropyltriethoxysilane, N-(β-aminoethyl)-γ-aminopropyltrimethoxysilane, γ-mercaptopropyltrimethoxysilane, and α-(ethoxycarbonyflethyltrimethoxysilane. Particularly preferred are γ-methacryloyloxypropyltrimethoxysilane and γ-glycidyloxypropyltrimethoxysilane. These may be used individually, or more than two of these may be used. The quantity of the organoalkoxysilane is 0.01 to 20 parts by weight to 100 parts by weight of the (A) component, preferably 0.05 to 20 parts by weight. At less than 0.01 parts by weight, it is difficult to obtain the effect of the alkoxysilane, and use of more than 20 parts by weight is not preferable because release of cured materials from the mold is deteriorated and a change of hardness is observed after curing.

In addition to the above (A) to (G) component, the composition may contain various inorganic or organic fillers to improve the physical properties of the composition. Examples of the fillers are fumed silica, precipitated silica, pulverized silica, diatomaceous earth, iron oxide, zinc oxide, titanium oxide, calcium carbonate and carbon black. The quantity of the fillers is optional, in a range such that the purpose of the present invention is not impaired. Further, the composition may contain known inhibitors such as acetylenic alcohols, vinyl-containing polyorganosiloxanes, triallylisocyanurates, and acetylene-containing silanes or siloxanes. The composition of the present invention may be diluted by organic solvent as specific applications require.

The adhesive composition of the present invention is obtained by mixing the above (A) to (F) components and the optional components. Preferably the composition is obtained by mixing the (A) component and optional components such as fillers at 100 to 200° C. for 1 to 4 hours using a planetary mixer or kneader and then mixing the (B), (C), (D), (E) and (F) components at room temperature. Molding methods may be selected according to the viscosity of the mixture, and any method such as casting, compression, injection, extrusion and transfer molding may be selected. Curing conditions are usually 60 to 200° C. and for 10 seconds to 24 hours.

The adhesive silicone rubber composition of the present invention is suitable to obtain integral moldings with the organic resins. Examples of the thermoset resins are polyurethane, phenolic resin, epoxy resin, urea resin, unsaturated polyester resin, melamine resin, alkyd resin and thermoset polyimide.

The method of integral molding for the uncured silicone rubber composition onto the above thermoset resin is exemplified by heating, at the curing temperature, the uncured silicone rubber composition which has a desired shape and is placed onto the molded thermoset resin; pressing the uncured silicone rubber composition onto the thermoset resin at a temperature lower than the curing temperature; and injection molding the thermoset resin into the mold followed by injecting the silicone rubber composition.

The addition curing silicone rubber composition may be liquid, putty like or pasty; however, it is preferable to be liquid or paste from easiness of molding. The curing conditions of the addition curing silicone rubber composition should be, for strong adhesion to the thermoset resin, at the temperature and time which do not cause change of shape or quality. The conditions vary by the type of the resin, but the integral moldings can be obtained, for example, with temperatures of 80 to 180° C. and times of 0.2 to 30 minutes.

The addition curing type silicone rubber composition of the present invention can be used as a coating agent on the surface of the thermoset resins. Depending on the method of coating, diluting agents may be added to adjust viscosity. There are no limitations on the diluting agent, and various organic solvents such as toluene, xylene, n-hexane, ethanol and isopropanol can be used. There are also no limitations on the method of coating, and it is preferable to use screen printing, spray coating or dip-coating. The coated film can be obtained by drying at 50 to 200° C. and 5 minutes to 3 hours after coating onto the thermoset resins.

The adhesive silicone rubber composition of the present invention cures quickly at relatively low temperature and achieves adhesion to various thermoset resins without change of adhesive strength and hardness over time. Particularly, the composition adheres well to polyurethane which was considered difficult to adhere. The composition can be used, for example, for key-pad of mobile phones which requires durability to repeated load to joint area between resin and rubber for long term use.

### EXAMPLES

The present invention is illustrated below by examples and comparative examples although it is not limited to the examples. All parts are by weight.

The delamination test and shape of sample pieces composed by silicone rubber and resin sheet are performed according to JIS K6256-2 (Adhesion test for cured rubber or thermoplastic rubber, section 6. “90 degree delamination test for solid plate and cured rubber”) in the examples and the comparative examples.

### Example 1

A kneader was charged with 100 parts of polydimethylsiloxane ((A) component) terminated by a dimethylvinylsilyl radical at each end and having a viscosity of 20,000 mPa·s at 25° C., 40 parts of fumed silica having a specific surface area of 200 m²/g, 8 parts of hexamethyldisilazane, and 1 part of ion-exchanged water. The ingredients were mixed by agitation for one hour at room temperature, followed by heating to 150° C. and then mixing for further 2 hours under heating. Thereafter, the mixture was cooled down to room temperature followed by adding 3.1 parts of polymethylhydrogensiloxane ((B) component)) composed by (CH₃)HSiO_{2/2} and (CH₃)₂SiO_{2/2} with ratio of 67/33 having a viscosity of 20 mPa·s, 20 parts of polymethylsiloxane resin((E) component, herein after RESIN 1) composed by 58 mol. % of (CH₃)₃SiO_{1/2}, 2 mol. % of (CH₂═CH) (CH₃)₂SiO_{1/2} and 40 mol. % of SiO_{4/2}, 0.8 parts of acetylene alcohol which extended the time for start of curing at room temperature, and 0.3 parts of platinum-vinylsiloxane complex solution having platinum content of 0.5 weight percentile, and then mixed further. Next, the silicone rubber composition was prepared by adding 0.5 parts of organosilicon compound ((C) component of the present invention) which is illustrated by the formula (i) below and 0.1 parts of zirconiumtetraacetylacetonate (ORGATICS ZC-150 manufactured by Matsumoto Fine Chemical Co.) to the above mixture.

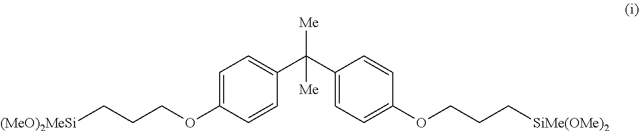

Sample pieces for the delamination test were prepared by filling the above silicone rubber composition into mold which has three cavities with length of 125 mm, width of 90 mm and thickness of 6.0 mm, and to which polyurethane sheets (PANDEX 4030 manufactured by DIC Co.) of 60 mm length, 25 mm width and 2 mm thickness were placed, and then curing at 120° C. for 10 minutes by compression cure. The delamination test was performed at room temperature and speed of 50 mm/min with autograph detection. Table 1 shows delamination strength and observation of peeled surface (ratio of cohesive failure (%)). The table 1 also shows test result on phenolic resin (AV LITE 811 manufactured by Asahi Organic Chemical Industry Co., Ltd.) or epoxy resin (AER-260 manufactured by Asahikasei Epoxy Co.) instead of polyurethane resin, and the results of the 90 degree delamination test and hardness by Type A Durometer for the samples 24 hours and one month after preparation.

### Comparative Example 1

The same method described in Example 1 was used except that the organosilicon compound (i) ((C) component) and zirconiumtetraacetylacetonate ((D) component) were not used. The silicone rubber composition was prepared, and sample laminates to polyurethane resin, phenolic resin and epoxy resin were made. Table 2 shows the results of the 90 degree delamination test and hardness by Type A Durometer for the samples 24 hours and one month after preparation of the samples.

### Comparative Example 2

The same method described in Example 1 was used except that the (E) component was not used. The silicone rubber composition was prepared, and sample laminates to polyurethane resin, phenolic resin and epoxy resin were made. Table 2 shows the results of the 90 degree delamination test and hardness by Type A Durometer for the samples 24 hours and one month after preparation of the samples.

### Comparative Example 3

The same method described in Example 1 was used except that γ-glycidyloxypropyltrimethoxysilane was used instead of the organosilicon compound (i) ((C) component) and zirconiumtetraacetylacetonate ((D) component). The silicone rubber composition was prepared, and sample laminates to polyurethane resin, phenolic resin and epoxy resin were made. Table 2 shows the results of the 90 degree delamination test and hardness by Type A Durometer for the samples 24 hours and one month after preparation of the samples.

### Example 2

The same method described in Example 1 was used except that diisopropoxytitaniumbis (ethylacetoacetate) (ORGATICS TC-750 manufactured by Matsumoto Fine Chemical Co.) was used instead of zirconiumtetraacetylacetonate ((D) component). The silicone rubber composition was prepared, and sample laminates to polyurethane resin, phenolic resin and epoxy resin were made. Table 1 shows the results of the 90 degree delamination test and hardness by Type A Durometer for the samples 24 hours and one month after preparation of the samples.

### Example 3

The same method described in Example 1 was used except that polymethylsiloxane resin ((E) component, herein after RESIN 2) composed by 15 mol. % of (CH₃)₃SiO_{1/2}, 20 mol. % of (CH₃)₂SiO_{2/2}, 25 mol. % of CH₃SiO_{3/2} and 40 mol. % of SiO_{4/2} was used instead of RESIN 1. The silicone rubber composition was prepared, and sample laminates to polyurethane resin, phenolic resin and epoxy resin were made. Table 1 shows the results of the 90 degree delamination test and hardness by Type A Durometer for the samples 24 hours and one month after preparation of the samples.

### Example 4

The same method described in Example 1 was used except that 0.5 parts of γ-glycidyloxypropyltrimethoxyxilane (SILA-ACE S 510 manufactured by Chisso Corporation) was further added. The silicone rubber composition was prepared, and sample laminates to polyurethane resin, phenolic resin and epoxy resin were made. Table 1 shows the results of the 90 degree delamination test and hardness by Type A Durometer for the samples 24 hours and one month after preparation of the samples.

### Example 5

The same method described in Example 4 was used except that methacryloxypropyltrimethoxysilane (SILA-ACE S 710 manufactured by Chisso Corporation) was used instead of γ-glycidyloxypropyltrimethoxyxilane. The silicone rubber composition was prepared, and sample laminates to polyurethane resin, phenolic resin and epoxy resin were made. Table 1 shows the results of the 90 degree delamination test and hardness by Type A Durometer for the samples 24 hours and one month after preparation of the samples.

### Comparative Example 4

The same method described in Example 4 was used except that the (E) component was not added. The silicone rubber composition was prepared, and sample laminates to polyurethane resin, phenolic resin and epoxy resin were made. Table 2 shows the results of the 90 degree delamination test and hardness by Type A Durometer for the samples 24 hours and one month after preparation of the samples.

### Comparative Example 5

The same method described in Example 4 was used except that 0.5 parts of organic compound represented by formula (ii) was used instead of organosilicon compound represented by formula (i) of (C) component. The silicone rubber composition was prepared, and sample laminates to polyurethane resin, phenolic resin and epoxy resin were made. Table 2 shows the results of the 90 degree delamination test and hardness by Type A Durometer for the samples 24 hours and one month after preparation of the samples.

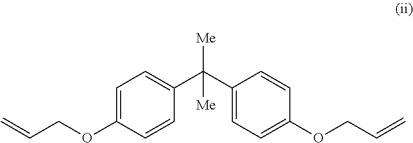

### Comparative Example 6

The same method described in Example 4 was used except that 0.5 parts of organosilicon compound represented by formula (iii) which did not have an aromatic group was used instead of organosilicon compound represented by formula (i) of (C) component. The silicone rubber composition was prepared, and sample laminates to polyurethane resin, phenolic resin and epoxy resin were made. Table 2 shows the results of the 90 degree delamination test and hardness by Type A Durometer for the samples 24 hours and one month after preparation of the samples.

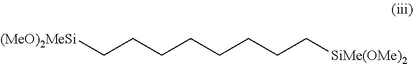

TABLE 1

| Example No | | | | 1 | 2 | 3 | 4 | 5 |
|---|---|---|---|---|---|---|---|---|
| (C) | Organosilicon compound (i) | | | 0.5 | 0.5 | 0.5 | 0.5 | 0.5 |
| Component | Organic compound (ii) | | | | | | | |
| | Organosilicon compound (iii) | | | | | | | |
| (D) | Zirconiumtetraacetylacetonate | | | 0.1 | | 0.1 | 0.1 | 0.1 |
| Component | Diisopropoxytitanbis(ethylacetoacetate) | | | | 0.2 | | | |
| (E) | RESIN 1 | | | 20 | 20 | | 20 | 20 |
| Component | RESIN 2 | | | | | 20 | | |
| (F) | γ-glycidyloxypropyltrimethoxysilane | | | | | | 0.5 | |
| Component | Methacryloxypropyltrimethoxysilane | | | | | | | 0.5 |
| Delamination Test | | | | | | | | |
| Organic resin | Time | Items | Unit | | | | | |
| Polyurethane | 24 | Hardness | | 50 | 51 | 51 | 53 | 53 |
| | hours | Adhesive strength | (N/mm) | 18 | 24 | 19 | 22 | 25 |
| | | Ratio of co-hesive fracture | (%) | 100 | 100 | 95 | 100 | 100 |
| | 1 | Hardness | | 50 | 51 | 51 | 53 | 53 |
| | month | Adhesive strength | (N/mm) | 19 | 24 | 20 | 24 | 26 |
| | | Retention of adhesive strength | (%) | 105.6 | 100.0 | 105.3 | 109.1 | 104.0 |
| | | Ratio of co-hesive fracture | (%) | 100 | 100 | 95 | 100 | 100 |
| Phenolic | 24 | Adhesive strength | (N/mm) | 16 | 21 | 17 | 20 | 20 |
| resin | hours | Ratio of co-hesive fracture | (%) | 95 | 100 | 90 | 100 | 100 |
| | 1 | Adhesive strength | (N/mm) | 17 | 21 | 18 | 22 | 21 |
| | month | Retention of adhesive strength | (%) | 106.3 | 100.0 | 105.9 | 110.0 | 105.0 |
| | | Ratio of co-hesive fracture | (%) | 100 | 100 | 95 | 100 | 100 |
| Epoxy resin | 24 | Adhesive strength | (N/mm) | 19 | 26 | 21 | 23 | 26 |
| | hours | Ratio of co-hesive fracture | (%) | 100 | 100 | 100 | 100 | 100 |
| | 1 | Adhesive strength | (N/mm) | 21 | 27 | 21 | 24 | 27 |
| | month | Retention of adhesive strength | (%) | 110.5 | 103.8 | 100.0 | 104.3 | 103.8 |
| | | Ratio of co-hesive fracture | (%) | 100 | 100 | 95 | 100 | 100 |

TABLE 2

| Comparative example No | | | | 1 | 2 | 3 | 4 | 5 | 6 |
|---|---|---|---|---|---|---|---|---|---|
| (C) | Organosilicon compound (i) | | | | 0.5 | | 0.5 | | |
| Component | Organic compound (ii) | | | | | | | 0.5 | |
| | Organosilicon compound (iii) | | | | | | | | 0.5 |
| (D) | Zirconiumtetraacetylacetonate | | | | 0.1 | | 0.1 | 0.1 | 0.1 |
| Component | Diisopropoxytitanbis(ethylacetoacetate) | | | | | | | | |
| (E) | RESIN 1 | | | 20 | | 20 | | 20 | 20 |
| Component | RESIN 2 | | | | | | | | |
| (F) | γ-glycidyloxypropyltrimethoxysilane | | | | | 0.5 | 0.5 | 0.5 | 0.5 |
| Component | Methacryloxypropyltrimethoxysilane | | | | | | | | |
| Delamination Test | | | | | | | | | |
| Organic resin | Time | Items | Unit | | | | | | |
| Polyurethane | 24 | Hardness | | 45 | 48 | 51 | 48 | 47 | 48 |
| | hours | Adhesive strength | (N/mm) | <1 | 3 | 8 | <1 | 4 | <1 |
| | | Ratio of co-hesive fracture | (%) | 0 | 5 | 25 | 0 | 5 | 0 |
| | 1 | Hardness | | 45 | 48 | 55 | 48 | 47 | 48 |
| | month | Adhesive strength | (N/mm) | <1 | 2 | 4 | <1 | 3 | <1 |
| | | Retention of adhesive strength | (%) | — | 66.7 | 50.0 | — | 75.0 | — |
| | | Ratio of co-hesive fracture | (%) | 0 | 0 | 10 | 0 | 0 | 0 |
| Phenolic | 24 | Adhesive strength | (N/mm) | <1 | 2 | <1 | <1 | 2 | <1 |
| resin | hours | Ratio of co-hesive fracture | (%) | 0 | 5 | 0 | 0 | 0 | 0 |
| | 1 | Adhesive strength | (N/mm) | <1 | <1 | <1 | <1 | <1 | <1 |
| | month | Retention of adhesive strength | (%) | — | — | — | — | — | — |
| | | Ratio of co-hesive fracture | (%) | 0 | 0 | 0 | 0 | 0 | 0 |
| Epoxy resin | 24 | Adhesive strength | (N/mm) | <1 | 3 | <1 | <1 | 3 | <1 |
| | hours | Ratio of co-hesive fracture | (%) | 0 | 5 | 0 | 0 | 5 | 0 |
| | 1 | Adhesive strength | (N/mm) | <1 | <1 | <1 | <1 | <1 | <1 |
| | month | Retention of adhesive strength | (%) | — | — | — | — | — | — |
| | | Ratio of co-hesive fracture | (%) | 0 | 0 | 0 | 0 | 0 | 0 |

1-4. (canceled)

5. A silicone rubber composition which is adhesive to thermoset resins, comprising:
(A) 100 parts by weight of a polyorganosiloxane having at least two siloxane units represented by formula (1) and a viscosity of 10 to 500,000 mPa·s at 25° C.,
R¹ₐR²_{b}SiO_{(4-a-b)/2} (1),
wherein
R¹ is alkenyl group,
R² is substituted or unsubstituted monovalent hydrocarbon group free of aliphatic unsaturation,
a is 1 or 2,
b is 0, 1 or 2,
and the sum of a and b is 1, 2 or 3;
(B) a polyorganohydrogensiloxane having siloxane units represented by formula (2) and which has at least two hydrogen atoms bonded to silicon atoms, in an amount such that the ratio of hydrogen atoms bonded to silicon in component (B) to alkenyl groups in component (A) is 0.5 to 7.0,
R²_{c}H_{d}SiO_{(4-c-d)/2} (2),
wherein
R² is substituted or unsubstituted monovalent hydrocarbon group free of aliphatic unsaturation,
c is 0, 1, 2 or 3,
d is 0, 1 or 2,
and the sum of c and d is 1, 2 or 3,
(C) 0.01 to 10 parts by weight relative to 100 parts (A) of an organosilicon compound having at least one aromatic hydrocarbon group and at least one alkoxy group bonded to silicon,
(D) 0.01 to 5 parts by weight relative to 100 parts (A) of an organometal compound which is a catalyst for a condensation reaction of (C),
(E) 10 to 200 parts by weight relative of a polyorganosiloxane resin whose average siloxane units are represented by formula (3), and comprises of 0 to 80 mol % of triorganosiloxane units, 0 to 60 mol % of diorganosiloxane units, 0 to 80 mol % of monoorganosiloxane units and 0 to 60 mol % of SiO_{4/2} units
R³ₑSiO_{(4-e)/2} (3),
wherein
R³ are identical or different alkyl of 1 to 12 carbon atoms or alkenyl groups of 2 to 12 carbon atoms, and
e is 0.5 to 2.0, and
(F) a catalytic amount of hydrosilylation reaction catalyst.

6. The silicone rubber composition of claim 5, wherein component (E) is a polyorganosiloxane resin containing at least one alkenyl group.

7. The silicone rubber composition of claim 5, wherein component (E) is a polyorganosiloxane resin containing triorganosiloxane units of 10 to 80 mol. % and SiO_{4/2} units of 20 to 90 mol. %, relative to the total of all siloxane units.

8. The silicone rubber composition of claim 6, wherein component (E) is a polyorganosiloxane resin containing triorganosiloxane units of 10 to 80 mol. % and SiO_{4/2} units of 20 to 90 mol. %, relative to the total of all siloxane units.

9. The silicone rubber composition of claim 5, further comprising at least one organoalkoxysilane (G) in an amount of 0.01 to 20 parts by weight based on 100 parts (A).

10. The silicone rubber composition of claim 6, further comprising at least one organoalkoxysilane (G) in an amount of 0.01 to 20 parts by weight based on 100 parts (A).

11. The silicone rubber composition of claim 7, further comprising at least one organoalkoxysilane (G) in an amount of 0.01 to 20 parts by weight based on 100 parts (A).

12. The silicone rubber composition of claim 8, further comprising at least one organoalkoxysilane (G) in an amount of 0.01 to 20 parts by weight based on 100 parts (A).
